(19) United States
(12) Patent Application Publication
(10) Pub. No.: US 2022/0267931 A1
(43) Pub. Date: Aug. 25, 2022

(54) Spider Silk Proteins - Small Particle Process and Products

(71) Applicant: Robert Rapp, San Jose, CA (US)

(72) Inventor: Robert Rapp, San Jose, CA (US)

(21) Appl. No.: 17/740,142

(22) Filed: May 9, 2022

Related U.S. Application Data
(63) Continuation-in-part of application No. PCT/US20/60303, filed on Nov. 12, 2020.
(60) Provisional application No. 62/934,648, filed on Nov. 13, 2019.

(51) Int. Cl. D01F 1/10; C01G 23/00; D01F 4/00

(52) U.S. Cl. CPC D01F 1/10; C01G 23/006; D01F 4/00; C01P 2004/64; B82Y 30/00

(57) ABSTRACT

The present disclosure is directed to new materials, to processes, products, and apparatus for controlling the production of new materials with enhanced properties. Processing, including layering, Nano-infusion, and other methods for combining spider silk proteins with ceramics, metals, graphene, and/or other stiff materials is now feasible using current technologies to provide new materials and/or products with enhanced and controlled properties. Products may be fabricated to control the flexibility of ceramics, metals, graphene, or other materials to specifications not previously attainable based on the presence of proteins, such as man-made spider silk proteins or webbing. Nanoparticles of one or more types of materials and spider silk proteins or webbing, such as nanoparticles of Barium Titanium Oxide (BaTiO₃), aluminum, titanium, graphene, steel, and compounds that include proteins may be combined to create new materials and products via processes that may include heating and/or pressurization at conditions that do not degrade the proteins.

### CROSS REFERENCE TO RELATED APPLICATIONS

The present disclosure is a continuation in part of related patent application PCT/US20/60303, filed on Nov. 11, 2020. This application claims priority benefit to patent application PCT/US20/60303 and to U.S. provisional patent application 62/934,648 entitled Spider Silk—Nanoparticle Process and Product filed Nov. 13, 2019, the disclosures of which is incorporated by reference herein.

### BACKGROUND OF THE INVENTION

### Field of Invention

The present disclosure generally relates to processes for making new materials. More specifically, the present disclosure is directed to new materials that includes elements that were previously impractical or impossible to combine.

### Description of the Related Art

For years it has been known that by weight, spider silk is stronger than steel. In fact, spider silk can be five to ten times stronger than steel. The commercial production of spider silk was once thought to be impossible because spiders cannot be grown in colonies large enough to product spider silk in large quantities. First it would take a large number of spiders to produce spider silk at levels necessary to support industrial production and secondly spiders are competitive and will attack and kill one another when they are in close proximity. These factors mean that one could not effectively grow and contain enough spiders to affordably produce spider silk at commercial levels.

In recent years, scientists have changed the genetics of goats and of silk worms. Goats have been genetically modified to manufacture spider silk proteins in their milk and silk worms have been genetically modified to produce spider silk in their spinnerets. This is resulting in the building of factories that produce spider silk proteins from goat's milk and webbing that includes spider silk proteins from genetically modified silkworms. Plants such as alfalfa are also being genetically engineered to produce spider silk proteins.

Sometime after the Apollo astronauts brought Moon dust back from the Moon, researchers who were provided with samples of Moon dust performed experiments on their Moon dust samples. One researcher in particular notice that Moon dust was slightly magnetic, indicating that Moon dust may include some iron. This particular researcher placed some Moon dust in his household microwave oven and noticed something unexpected: The Moon dust melted at an unusually low temperature forming a glass like substance. Scientists then theorized that the Moon naturally produces nanoparticles. Nanoparticles are typically defined to be particles that are between 1 and 100 nanometers in size. Science now believes that the Solar Wind and meteors impacting the surface of the Moon over millennia pulverized the surface of the Moon as part of a process that forms nanoparticles. This process may have also been assisted by meteors or micro-meteors impacting the surface of the Moon. Scientists also theorized that the physics of nanoparticles is different from particles of similar substances that naturally appear on Earth.

In recent years, individuals experimenting with man-made nanoparticles have identified that ceramics can be sintered at temperatures less than 200 degrees Celsius (less than 392 degrees Fahrenheit). For example, nanoparticles of Barium Titanium Oxide (BaTiO₃—also referred to as Barium Titanate) have been used to form a ceramic material by heating (sintering) BaTiO₃ at temperatures less than 200 degrees Celsius (C). Furthermore, various companies are now experimenting with many different materials that are considered nanoparticles

The development of new materials over the past tens of thousands of years has allowed mankind (humanity) to increase the relative potential population density of the planet Earth. This is because the development of new materials both helped improve the efficiency of old methods and helped humanity create new apparatus/products that could not have been produced before. For example, the first metal tools were built from copper. After copper, man developed the ability to create and manipulate bronze, brass, iron, steel, aluminum, and titanium. These developments allowed mankind to plow fields more efficiently, cut trees more efficiently, and create airplanes that can fly massive amounts of cargo around the world. As such, the development of new materials is tightly linked with the productive capabilities of the human species.

Since all technological progress requires science and since new materials help drive scientific and technological process, what are needed are new materials and new ways to products made from these new materials.

### SUMMARY OF THE PRESENTLY CLAIMED INVENTION

The present disclosure is directed to methods, apparatus, and non-transitory computer readable storage media where a processor executes instructions out of a memory to control or perform a method. In a first embodiment, a method form making a product with the present disclosure may include placing a first set of measures of critically sized particles of a material and a first set of measures of a protein in a vessel. These critically sized particles may have a major dimension that is less than a first size. The measures of the critically sized particles and the protein may be heated to a first temperature that softens the critically sized particles and that does not destroy the protein to form the product.

In a second embodiment, a method for combining materials may include controlling a flow of a protein containing substance through a first nozzle of one or more nozzles and by controlling the flow of a heated material that includes critically sized particles through at least one of the first nozzle or a second nozzle of the one or more nozzles. Proteins in the protein containing material and the critically sized particles are combined based on the heating of the critically sized particles and the passage of the protein containing material and the heated material through the one or more nozzles.

In a third embodiment, a method may include placing a portion of webbing material that includes the spider silk proteins in proximity to an apparatus that distributes critically sized particles onto at least a part of the portion webbing material, and distributing the critically sized particles onto the webbing material based at least in part on the webbing material being placed in proximity to the apparatus.

The aforementioned webbing or proteins may include manmade spider silk proteins or webbing made from or by genetically engineered organisms. The critically sized particles may be nanoparticles or particles that are suitable for use based on their size.

### BRIEF DESCRIPTION OF THE DRAWINGS

FIG. 1 includes a series of steps that may be used to create a material that includes one or more substances and spider silk proteins or webbing.

FIG. 2 illustrates steps of a process to fabricate a new material from liquid that contains spider silk proteins.

FIG. 3 illustrates a method for combining proteins with particles of a critical size.

FIG. 4 illustrates that methods for combining proteins with particles of a critical size are not limited to a specific order of steps.

FIG. 5 illustrates a method for combining proteins with particles of a critical size.

FIG. 6 illustrates a process for making new materials from spider webbing.

FIG. 7 illustrates various different ways in which materials may be pressurized when new materials are made.

FIG. 8 illustrates an injection molding machine and a three dimensional printing system that may be used to produce materials consistent with the present disclosure

FIG. 9 illustrates two different sets of apparatus that may be used to produce products or materials consistent with the present disclosure.

FIG. 10 illustrates exemplary camming apparatus that may move a nozzle to coat only portions of a spider web strand(s) with other materials.

FIG. 11 illustrates features that may be included in nozzles that dispense combinations of materials at preferred temperatures and pressures

FIG. 12 illustrates a computing device that may be used to control or monitor apparatus consistent with the present disclosure.

### DETAILED DESCRIPTION

The present disclosure is directed to new materials, to processes, products, and apparatus for controlling the production of new materials with enhanced properties. Processing, including layering, Nano-infusion, and other methods for combining spider silk proteins with ceramics, metals, graphene, and/or other stiff materials is now feasible using current technologies to provide new materials and/or products with enhanced and controlled properties. Products may be fabricated to control the flexibility of ceramics, metals, graphene, or other materials to specifications not previously attainable based on the presence of proteins, such as man-made spider silk proteins or webbing. Nanoparticles of one or more types of materials and spider silk proteins or webbing, such as nanoparticles of Barium Titanium Oxide (BaTiO₃), aluminum, titanium, graphene, steel, and compounds that include proteins may be combined to create new materials and products via processes that may include heating and/or pressurization at conditions that do not degrade the proteins in at least a first processing step.

Proteins of various sorts may be combined with other materials that do not contain proteins. In certain instances, spider silk protein containing materials (e.g. Man-made spider webbing or spider silk proteins) may be combined with other materials to make new materials or products. Some materials combined with proteins may include a major dimension (e.g. such as a width, diameter, height, length, or circumference) that is 100 nanometers (nm) or less in size. Other materials combined with proteins may include a critical dimension that is less than or equal to some other size (e.g. 250 nm, 300 nm, 500 nm, 700 nm, 1000 nm, 1500 nm, 100 um, 1000 um, or other size).

In certain instances, a specific material with a small particle size may be melted at temperatures that are lower than temperatures typically consistent with processing of that specific material. For example, nanoparticles of Barium Titanium Oxide (BaTiO₃) may be combined with spider silk web or spider silk protein and heated to a temperature that melts the small particles of BaTiO₃ and that does not destroy the strength of the spider silk web or protein. Spider silk webbing has been reported to retain its strength even when chilled to a critical temperature (e.g. −40 degrees C.) or when heated to a temperature of 220 degrees C. Since BaTiO₃ can be sintered into a ceramic product at temperatures less than 200 degrees C., methods consistent with the present disclosure may be used to produce ceramic products at temperatures that are lower than temperatures that would degrade or destroy spider silk webbing or spider silk proteins. Such a process may produce ceramic with selected characteristics that may include enhanced durability, strength, or flexibility. In certain instances, combinations of spider silk proteins or webbing and ceramic nanoparticles may be used to produce a strong flexible form of ceramic tailored to fit the needs of a particular application. After a first processing step that forms a new material, that material may be exposed to temperatures that do exceed temperatures where spider silk protein or webbing degrades or is destroyed. Such a second heating step may be performed after the new material that was made based on a change that occurred to the combined materials during the first heating step.

The present disclosure is not limited to the production of ceramic materials as other materials may be used to make different types of new materials. In certain instances, products may be fabricated from proteins and several different types nanoparticles. For example, metallic and ceramic nanoparticles may be used.

The present disclosure is also not limited to combining spider silk webbing or spider silk proteins with small particles or nanoparticles of one or more types of materials. In certain instances, materials or products may be manufactured that combine spider silk webbing or spider silk proteins with materials that have larger particle sizes than what are conventionally considered to be nanoparticles. Furthermore, new types of materials or products may be manufactured that combine spider silk proteins/webbing or materials of larger sizes. Because of this, materials or products consistent with the present disclosure include those made by combining materials that include proteins (that may include Man-made spider webbing, manmade spider silk proteins, or other proteins) with materials that do not include proteins.

For example, any material that has a small particle size or a nanoparticle size may be combined with spider silk webbing or spider silk proteins and heated to form new materials. Examples of small particle or nanoparticle types include yet are not limited to any ferrous or nonferrous metal (e.g. iron, aluminum, gold, silver, steel, copper, or other metal), graphene, other types of nanoparticles, or combinations of different types of small particles (that may be larger than 100 nm). Substances may be made that include one or more metals, ceramics, other nanoparticles, and proteins (e.g. spider silk proteins or spider silk webbing). Methods of the present disclosure may include applying microwave energy to heat materials during a manufacturing process. A process may include combining materials that melt at a desired temperature. For example, silver nanoparticles at a size of less than 5 nm (e.g. 2 nm) that melt below 200 degrees Celsius.

New materials may be made by controlling a pressure when one or more types of small or nanoparticles are combined with spider silk webbing or spider silk proteins. Examples of pressurized environments include a mold pressurized by a clamp or press, injection molding, passing a volume of particles through a nozzle at a controlled volume or velocity, or by combining the materials in a pressure chamber. In certain instances, specific types of nanoparticles may be combined with manmade spider silk proteins. In other instances, particles may be combined with spider silk webbing that already exists or that has been previously fabricated. As such, select protein containing substances may be combined with nanoparticles or small particles of one or more types of materials.

Processes for making these new materials may also include introducing other materials that may volatize or evaporate when heated. For example, water, de-ionized water, ethanol, or other liquids may be combined with spider silk proteins or nanoparticles of one or more types and these substances may be heated. In such instances the spider silk proteins or the nanoparticles may be treated or coated such that they disperse in the liquid instead of floating or sinking. In other instances, spider silk proteins or nanoparticles may be combined without them being treated or coated to disperse in a liquid.

Man-made spider silk webbing may have been made from spider silk proteins. These proteins may be of a size that is itself a small particle or a nanoparticle size. Furthermore, other forms of substances may have been obtained from an “entity” (plant, animal, insect, virus, bacteria, algae, or other) may be used when producing new materials. For example, materials that include the basic building blocks of life such ribonucleic acid (RNA) or deoxyribonucleic acid (DNA) may be used. As such processes consistent with the present disclosure are not limited to using materials derived from entities that include RNA or DNA, such as: animals (e.g. mammals or goats), insects (e.g. silk worms), plants (e.g. alfalfa, cannabis, wheat, or grain), or microorganism (e.g. algae, bacteria, or virus). Furthermore, these entities from which materials are sourced may have been genetically engineered to produce specific compounds such as RNA, DNA, spider silk proteins, or webbing (e.g. spider or silk worm webbing).

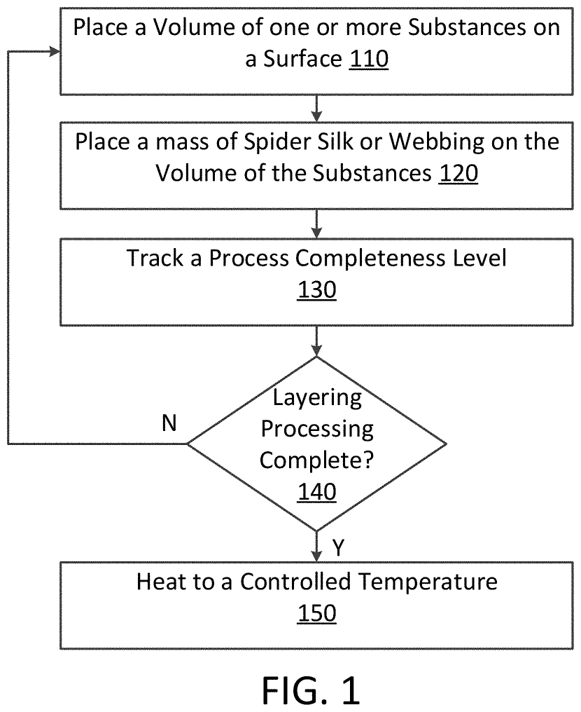

FIG. 1 includes a series of steps that may be used to create a material that includes one or more substances and spider silk materials (webbing or proteins). Step 110 of FIG.1 is a step where a volume of one or more substances is placed on a surface. For example, a volume of BaTiO₃ may be placed on a surface or in a mold. Next in step 120 of FIG. 1, a mass of spider silk may be placed on top of the volume of the one or more substances. Each of these one or substances may be a type of particle of a desired size (such as a nanoparticle size, or other size). Optional step 130 may be a step where a completeness level of the process is tracked. Step 130 may include counting a number of layers (e.g. by incrementing one or more counters that tracks a number of layers of specific types). Next determination step 140 may identify whether a layering or other pre-processing process has been completed. For example, a particular process may include 11 layers. In certain instances a first and second layer may include spider silk proteins and so on. As such a first layer and a last layer may consist of BaTiO₃ and a last layer of BaTiO3between alternating layers of spider silk BaTiO₃. Alternatively external layers may be made of spider silk proteins or webbing and other layers may include nanoparticles of a selected type. While not illustrated in FIG. 1, a liquid such as water, de-ionized water, or ethanol may be added to the mixture of materials before or when those materials are processed. The steps of FIG. 1 may also include pressurizing a set of materials.

When determination step 140 identifies that the layering process is not complete, program or process flow may move back to step 110 where an additional volume of one or more substances are placed on top of substances that were previously placed on the surface. In certain instances, one external layer may be the small particles or nanoparticle material and another external layer may be spider silk webbing or protein.

When determination step 140 identifies that the layering process is complete, program or process flow may move to step 150 where the layered materials may be heated to a controlled temperature. For example, when the nanoparticle material is BaTiO₃, the spider silk BaTiO₃ materials may be heated to a temperature of 180 to 200 degrees C. until the BaTiO₃ materials melt in a cold sintering process. When the combined materials include graphene particles, the heating may not exceed a temperature of about 130 degrees C. to avoid degrading the graphene particles. After the materials have been heated to such temperatures, they may be cooled or they may be heated to a higher temperature. The materials being heated may also be pressurized by squeezing those materials in a mold with a clamp, by injection molding, by placing the materials in a pressure vessel, or by passing the materials through a nozzle. Methods of the present disclosure may include applying microwave energy to heat materials during a manufacturing process.

After these materials are combined at a first temperature, these materials may be heated again to temperatures that exceed the original 180 temperature. As such, materials may be combined or sintered at a temperature less than a temperature where the proteins or webbing breakdown. This first heating or sintering process may chemically change a resulting mixture resulting in a material or product that may withstand temperatures that exceed the breakdown temperature of the proteins or webbing. These processes may include first heating process that acts as a sintering step and may be heated to a higher temperature that acts as an annealing step. When two different heating steps are used, the combined materials may be allowed to cool after the first heating step and then heated again. Alternatively, the second heating step may proceed immediately after the combined materials have been heated for a time at the first temperature.

The present disclosure is not limited to the steps of FIG. 1. Processes consistent with the present disclosure may be used to combine nanoparticles or other small particles and spider silk proteins before the combination is heated to a desired temperature. In certain instances, layers of spider silk may be placed as a set of lines arranged in a pattern of geometric shapes in a pattern similar to patterns included in spider webs, zig-zag patterns, or other patterns, for example.

In certain instances, cocoons or portions of cocoons that may include spider silk (that may have been produced by silk worms) may be placed between layers of nanoparticles and then the nanoparticles may be melted. Strands or cocoons of spider silk may be impregnated with nanoparticles or other sized particles, such processes may include spraying selected particles onto or into a mass of webbing that includes spider silk proteins. This may be performed as or after the small particles or nanoparticles have been melted. This may include melting small particles and spraying the melted particles, accelerating the particles in a stream of liquid or gas (like sandblasting), or may include depositing or implanting particles in an ion implant machine.

In another example a volume of nanoparticles may be combined with goat milk that contains spider silk, watery materials may be heated and evaporated from the goat milk, and the remaining combination may be heated to a desired temperature that melts the nanoparticles when combining them with the spider silk proteins and other materials included in the goat milk.

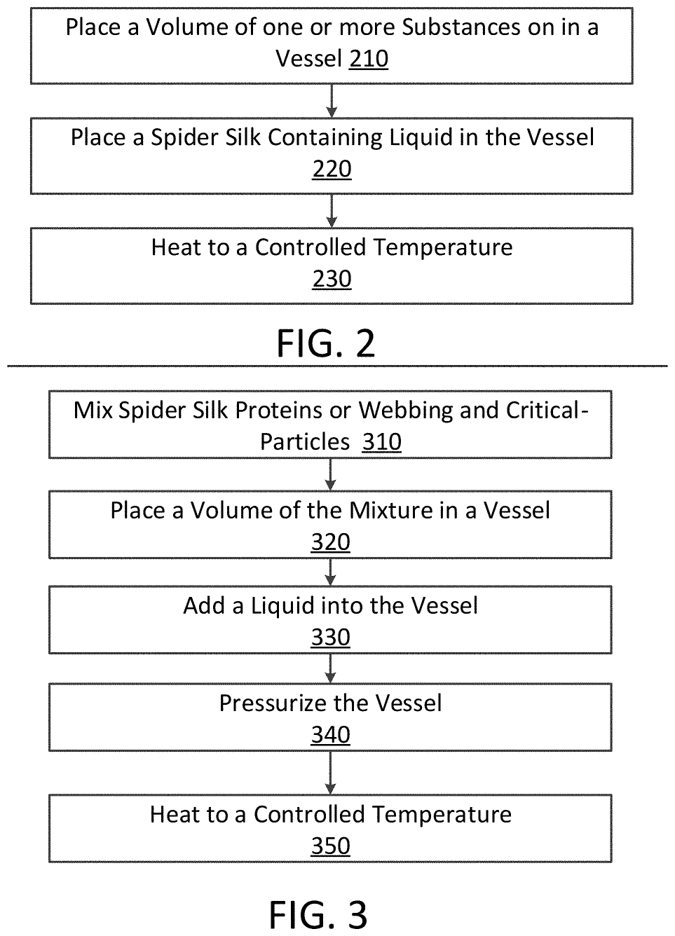

FIG. 2 illustrates steps of a process to fabricate a new material from liquid that contains spider silk proteins. A first step of FIG. 2 includes step 210 where a volume of one or more substances (e.g. nanoparticles) is/are placed in a vessel. This vessel could be a mold, for example. Step 220 of FIG. 2 is where a spider silk containing liquid is placed in the vessel. Next in step 230, the mixture is heated. This heating may evaporate liquid, leaving spider silk proteins distributed in the vessel with the one or more other substances/nanoparticles. The heating could continue until the one or more substances are melted. In such processes, raw goat spider silk containing milk could be introduced into the vessel or pre-processed goat spider silk containing milk could be introduced into the vessel. Pre-processed goat spider silk containing milk may be low fat or skim milk made from goat spider silk milk. Furthermore, materials included in spider silk milk may be separated in a centrifuge, by allowing fat to float to the top of a volume of the spider silk milk, or solvents (e.g. ethanol, hexane, or water) may be added to the milk to facilitate the separation of spider silk materials from other materials included in the spider silk milk before step 220 of FIG. 2 is performed. In similar ways, spider silk proteins in a particle form may be combined with other materials. As mentioned above, these processes may include combining critical materials with a liquid before or as these materials are combined. The process of FIG. 2 may include pressurizing the substances and proteins.

Processes may include melting nanoparticles at temperatures that do not weaken or destroy the strength of spider silk. This process may include two heating steps as discussed above.

In certain instances, the spinning of spider silk may be combined with the infusion of nanoparticles as the spider silk is spun. The combination may be heated to a controlled temperature as spider silk is spun or after the spinning of the spider silk. The combination may also be formed into a structure and heated to a temperature that melts the nanoparticles.

Products and materials consistent with the present disclosure may be manufactured using masses of nanoparticles or small and spider silk in different ratios by weight or by volume. For example, a mass or a volume of spider silk as compared to a mass or volume of nanoparticles may be less than 1% to greater than 99%. Other exemplary spider silk/nanoparticle rations are 5%/95%, 10%/90%, 25%/75%, 50%/50%, 90%/10%, and 95%/10%.

FIG. 3 illustrates a method for combining proteins with particles of a critical size. FIG. 3 includes step 310 where proteins, such as spider silk proteins are mixed or combined with particles of critical sizes. This volume may be combined in a vessel or placed in the vessel in steps 310 and step 320 of FIG. 3, or steps 310 and 320 may be combined in to a singles step where materials are added and combined or mixed. Liquid may be added to the vessel in step 330 and the vessel may be pressurized in step 340 of FIG. 3. The mixed materials may then be heated in step 350. Steps 310, 320, and 330 may be performed in any order before mixtures are heated and/or pressurized.

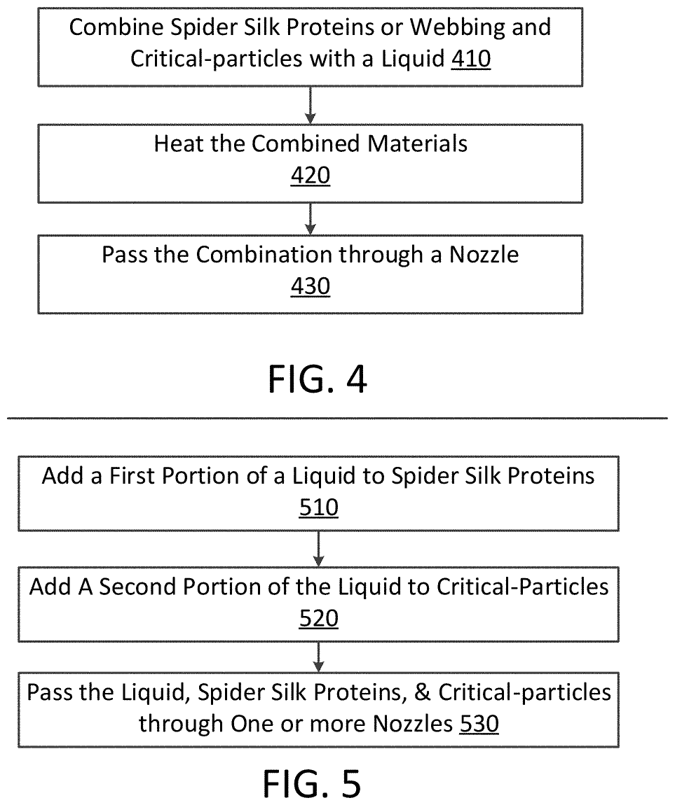

FIG. 4 illustrates that methods for combining proteins with particles of a critical size are not limited to a specific order of steps. Step 410 of FIG. 4 is a step where proteins, such as spider silk proteins, critical particles, and a liquid are combined. This mixture may be heated in step 420, and then be passed through a nozzle in step 430 of FIG. 4. By passing the heated mixture through a nozzle, the heated mixture will be pressurized. The nozzle itself may also be heated. The critical particles may be nanoparticles that are softened or melted during the heating process. A pressure associated with a flow rate through a nozzle of certain types may be calculated according to a formula, such as gallons per minute (GPM) equals (a constant K) times a nozzle diameter (D) squared) times the square root of a pressure (P): GPM=K D²(P)^{1/2}. As such JP=(GPM/K*D²) and P=(GPM/K*D²)².

FIG. 5 illustrates a method for combining proteins with particles of a critical size. Steps 510 and 520 may be performed concurrently. Step 510 of FIG. 5 is a step where a first portion of a liquid is added to or combined with spider silk proteins. Step 520 is a step where a second portion of the liquid is combined with critical particles that may again be nanoparticles or other sized particles. In certain instances, steps 510 and 520 may be performed concurrently.

The combining of spider silk proteins with the first potion of liquid may be accomplished by simply placing spider silk proteins in a first vessel and by placing a liquid such as water in the vessel. In certain instances, the spider silk proteins may be of a form that causes the spider silk proteins to be relatively evenly distributed (disperse) in the first portion of liquid. Similarly, the critical particles and a second portion of the liquid may be placed in a second vessel. Here again the critical particles may be of a form that results in the critical particles being relatively evenly distributed (disperse) in the second portion of liquid. Methods for treating nanoparticles to make them disperse include combining or coating nanoparticles with Polyvinylpyrrolidone (PVP). For example, PVP coated BATIO₃ nanoparticles are available for purchase from companies such as US Research Nanomaterials Inc.

Dispersing nanoparticles in a liquid may be performed using ultrasonic stimulation. For example, a company called Siansonic states that: “Nanoparticle dispersion means various nano-suspensions can be efficiently dispersed and transported by embedding the high-frequency ultrasonic transducer into a micro-container such as a sample injector/syringe to uniformly disperse the nano-scale and sub-micron particles and transport liquid. The sedimentation and agglomeration can be avoided in the transport and spray coating of suspension. The nanoparticle dispersion system can be installed in a variety of syringe pumps, and is often used as an auxiliary accessory unit in the precision spray coating system.”

Processes consistent with the present disclosure may disperse nanoparticles or proteins in a liquid various techniques that may include spray coatings, ultrasonic stimulation, or by other means known in the art. Such processes may be used to disperse nanoparticles or proteins in a volume of a liquid in a vessel or may be used to disperse nanoparticles or proteins in a volume of a liquid as part of a continuous feed system. For example, a continuous feed system may feed nanoparticles of a material and volumes of a liquid into a vessel or pipe as the combination is exposed to ultrasonic stimulation. In such instances, nanoparticles may be fed into a vessel or pipe using an Archimedes screw/screw pump or be pushed by a pressurized fluid (liquid or gas). At this time liquid may be pumped into the vessel or pipe using any pump known in the art (e.g. a peristaltic pump, a metering pump, a diaphragm pump, or any other pump suitable for pumping liquids or slurries). Alternatively, the liquid may be provided with the nanoparticles to an input of pump capable of pumping slurries (e.g. a combination of nanoparticles and liquid). Any pump known in the art capable of pumping such a slurry may be used, including pressuring a vessel using a vacuum pump. Vessels may be pressurized by moving a gas from a gas source, such as a pressurized cylinder of nitrogen.

Note that steps 510 and 520 may be performed concurrently in various controlled ways. Each of the different inputs, a combined output, or the nozzles may be heated before and/or when the various materials are passed through the one or more nozzles in step 530 of FIG. 5.

In certain instances, the liquid(s) may be heated prior to combining the liquid(s) with the proteins and/or nanoparticles. An inline heater may be also be used. For example, one or more pipes, vessels, or the nozzles from with materials are sourced or transported may be heated by a heating jacket. Such an inline heating process may be accomplished using coils that transport heated liquids that surround the pipes, vessels, or nozzles. Alternatively, or additionally, electric heaters may be used to heat the pipes, vessels, or nozzles as various materials are combined. In certain instances, a manufacturing process may be contained within a chamber that is itself heated to a desired temperature, in such instances, additional heaters may not be required as the chamber temperature itself may be used to control temperature of the process. Methods of the present disclosure may include applying microwave energy to heat materials during a manufacturing process. This may include the use of a microwave emitter or the chamber may form a microwave chamber.

Processes consistent with the present disclosure may also use source materials that already have been distributed in a liquid. For example, the spider silk proteins (of step 510) may already be dispersed in the first portion of liquid and the critical particles (of step 520) may already be dispersed in the second portion of the liquid and then these dispersions may be passed through the one or more nozzles in step 530. Here again the various input streams and/or the nozzles may be heated to a desired temperature before or as the various materials are combined.

The present disclosure is not limited to combining raw proteins, such as manmade spider silk proteins with critically sized particles. For example, manmade spider silk webbing or cocoons or webbing spun by silk worms may be used to make new materials or products. As such, spider silk webbing made from genetically engineered animals, plants, algae, or other organisms may be post processed after the spider silk webbing has been manufactured. As previously mentioned, spider silk proteins extracted from goat milk or from plants has been used to make manmade spider silk webbing. Furthermore, cocoons or webbing spun by genetically engineered silk worms that include spider silk proteins may be post processed in various ways.

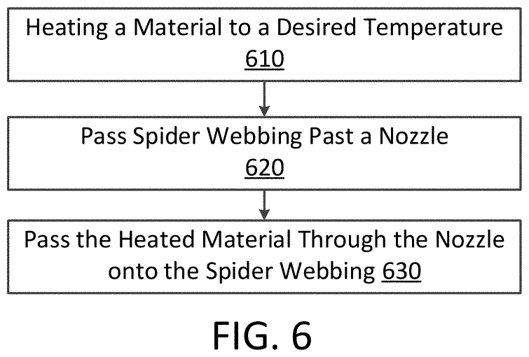

FIG. 6 illustrates a process for making new materials from spider webbing. Step 610 includes heating a material to a desired temperature. The material heated in step 610 may include nanoparticles or critically sized particles. The material heated in step 610 may also include a liquid. For example, water or a solvent may be combined with or mixed with nanoparticles of graphene. The heated material may be a dispersion of particles in a liquid that were previously created. Alternatively, one or more pumps (e.g. a peristaltic pump, a metering pump, a diaphragm pump, or any other pump suitable for pumping liquids or slurries) and or an Archimedes screw/screw pump may be used to feed materials (e.g. particles and/or a liquid) to a manufacturing process.

Step 620 of FIG. 6 is where spider webbing is moved past a nozzle as heated particles (or melted materials) are passed (extruded or sprayed) onto the spider webbing through a nozzle in step 630 of FIG. 6. The process of FIG. 6 may be performed immediately after the spider webbing has been made as part of an inline process. Alternatively, the spider webbing of step 610 may have been made previously. The spider webbing of step 610 may include one or more individual strands of spider silk webbing. For example, the spider webbing of step 610 may be prefabricated rope or be a single strand of spider webbing materials of any desired thickness or the webbing materials may be cocoons spun by silkworms.

The steps of FIG. 6 may be used to produce an electrically conductive wire or partially conductive wire, depending on the materials used. For example, graphene nanoparticles may be melted and sprayed onto the spider webbing as the spider webbing is drawn past the nozzle when a wire is fabricated. This may result in a wire that is electrically conductive and that is highly elastic.

In yet other instances, the spider webbing of step 610 may be passed through a bath of melted materials. By passing the spider webbing through this bath, the melted materials may partially or entirely coat the spider silk webbing.

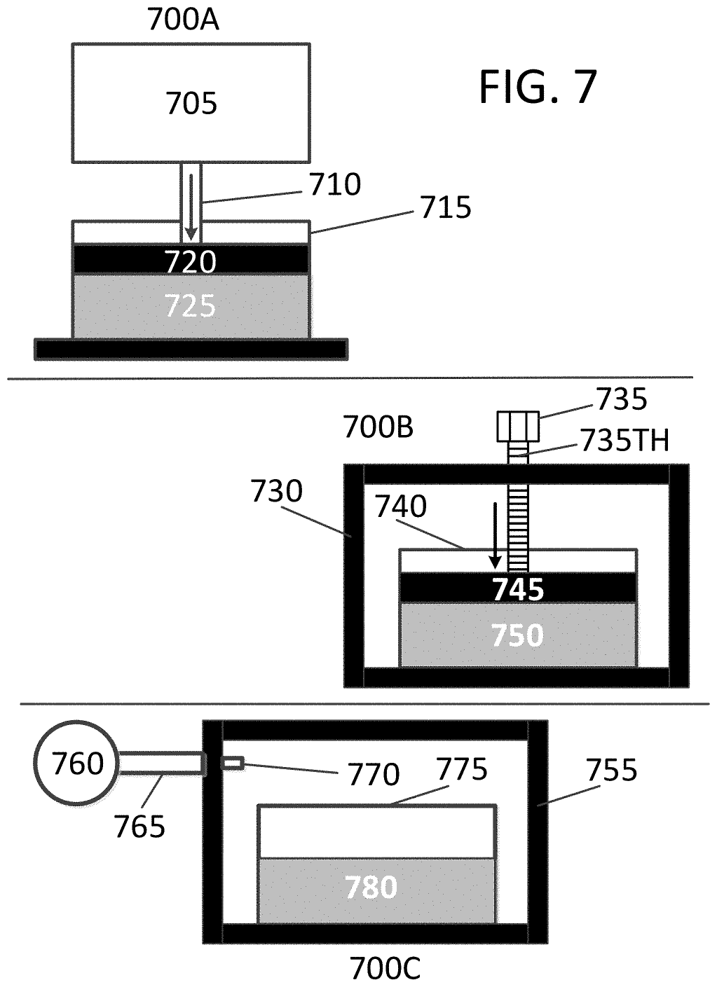

FIG. 7 illustrates various different ways in which materials may be pressurized when new materials are made. FIG. 7 includes a first type of pressure apparatus 700A that includes press 705 (e.g. a hydraulic press), member 710, mold 715, interface material 720, and a set of combined materials 725. After the set of combined materials 725 have been placed into mold 715, press 705 may force member 710 down (in the direction of the arrow of apparatus 700A) to compress combined materials 725 to a desired pressure when a material is formed in mold 715. The combined materials may be heated by heating mold 715 (via a heating jacket or heater coupled to mold 715 or by placing the entire apparatus 700A in a heating chamber). As mentioned above this chamber may be or may include a microwave energy source. During this process, interface material 720 may contain at least a portion of the materials 725 in mold 715. In instances when the combined materials 725 include a liquid (e.g. water or a solvent) the interface material 720 may allow vaporized portions of the liquid to escape from mold 715. In such instances, these vapors may escape mold 715 around edges of interface material 720. A force provided by press 705 & member 710 to interface material 720 will correspond to a pressure provided to an area associated with the combined materials inside of mold 715. Based on this, a force provided by press 705 may be used to control a pressure of the combined materials 725 inside of mold 715.

Apparatus 700B of FIG. 7 may operate in a similar manner as apparatus 700A of FIG. 7, here instead of a press a screw or bolt 735 is used to provide the pressure. Apparatus 700B includes clamp 730, bolt 735, mold 740, interface material 745, and combined materials 750. Mold 730 may include a threaded portion that allows threads 735TH to engage a threaded portion of mold 730 (not illustrated) such that bolt 735 moves downward (as illustrated by the arrow of apparatus 700B) pressing on interface material 745. The force provided by screw/bolt 735 may be controlled based on a torque. This torque (T) may correspond to a force (F) per unit area or square area applied to the combined materials 750, a screw/bolt diameter (D), and a coefficient (K).

One of ordinary skill in the art at the time of the invention would understand that a clamping torque (T) of a screw/bolt and force (F) applied to an area corresponds to the formula T=K*D*F. When a steel lubricated bolt of diameter 0.25 inches (D=0.25″) is used coefficient K should be about 0.18. In an instance when F=25 pounds (Lb), a torque T would equal (0.18) times (0.25″) times (25 Lb). As such T=(0.18)*(0.25″)*(25 Lb). This equation results in a torque T of 1.125 inch pounds. This may be converted to inch ounces by multiplying T by 16 (since there are 16 ounces in a pound). As such torque T=18 ounce inches.

In an instance when the mold had a diameter of 0.5 inches (0.5″ or radius R of 0.25″) a square area A of the combined materials is corresponds to the formula A=(PIE)*R²=3.14159*(0.25)². As such A=0.19635 square inches. From this a pressure (P) applied by the 25 pound force may be calculated by the formula P=F/A. As such, P=(25/0.19635)=127.323 pounds per square inch. Similar equations could be performed when calculating a pressure provided by press 705 of apparatus 705A.

FIG. 7 also includes apparatus 700C. Apparatus 700C includes pressure source 760, pipe 765, and nozzle 770, that are coupled to chamber 755. Inside of chamber 755 is mold 775 and combined materials 780. Pressure source 760 may be, for example a pressure cylinder that provide a gas (e.g. nitrogen) to chamber 755 via pipe 765 and nozzle 770. Alternatively pressure source 760 may be a pump that pumps a gas or that provides a pressurized gas to chamber 755 via pipe 765 and nozzle 770. A pressure inside of chamber 755 may be controlled by a valve and pressure gauge or may be electronically controlled. After materials 780 have been added to mold 775, chamber 755 may be sealed, and then pressurized. Chamber 755 may also be heated to a temperature when a new material is made. Chamber 755 may be a heating chamber or a pressure oven.

FIG. 7, thus illustrates three different apparatus that may be used to pressurize and heat combined materials in controlled ways. Each of these apparatus may be used to provide a given pressure and temperature to a set of combined materials to produce a new material within a mold.

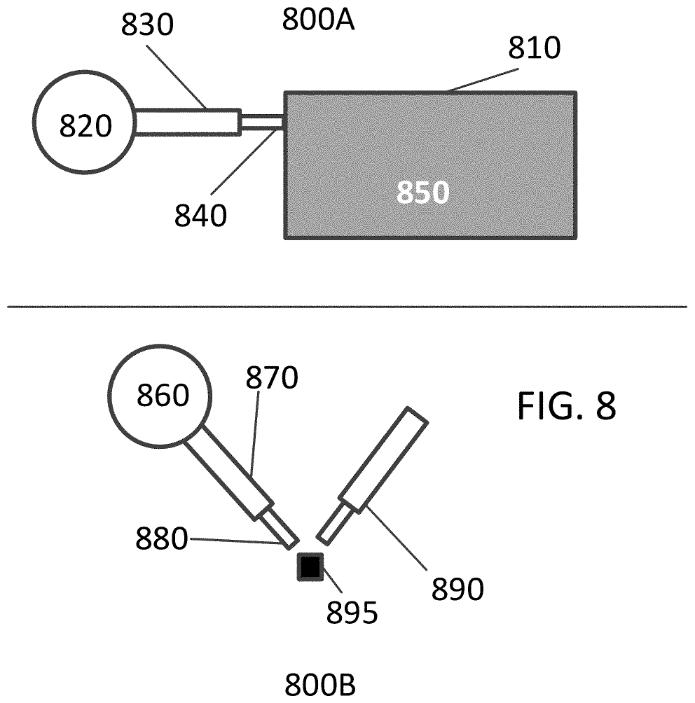

FIG. 8 illustrates an injection molding machine and a three dimensional printing system that may be used to produce materials consistent with the present disclosure. The injection molding apparatus 800A of FIG. 8 includes injection mold 810, material source 820, pipe 830, nozzle 840, and molded part 850. Materials may be combined or heated before they are pumped into mold 810. Material source 820 may include pumps or heaters that heat materials injected into mold 850 at controlled temperatures and pressures. In such instances, some of the materials may be in liquid form when pumped into mold 810 or may include portions of liquids. One or more nozzles may also be used in such an injection molding apparatus.

FIG. 8 also illustrates an exemplary three dimensional (3D) printing apparatus 800B that includes material source 860, tube 870, and nozzle 880. Materials may be provided from materials source 860 through tube 870 and nozzle 880 when layers of a product are printed. Here again materials may be heated to desired temperatures as or immediately after they are extruded. Item 890 of FIG. 8 is a heater that may provide an additional amount of heat such that critical temperatures are reached in a controlled way. Secondary heaters may be a heater of any type, e.g. a laser or a spark source (like a welder). As such materials 895 consistent with the present disclosure may be 3D printed using a primary heating system associated with material source 860, a secondary heating source, or both a primary and secondary heating source. This process may be performed in a pressurized container.

Alternatively heater 890 may heat a set of materials that are dispersed in a bed. For example, a mixture of spider silk proteins and nanoparticles may be dispersed in a bed (in layers for example) and a laser may heat the materials at a focal point when making material 895. Such processes may be used for example when combining metal or ceramic nanoparticles with proteins when making new materials.

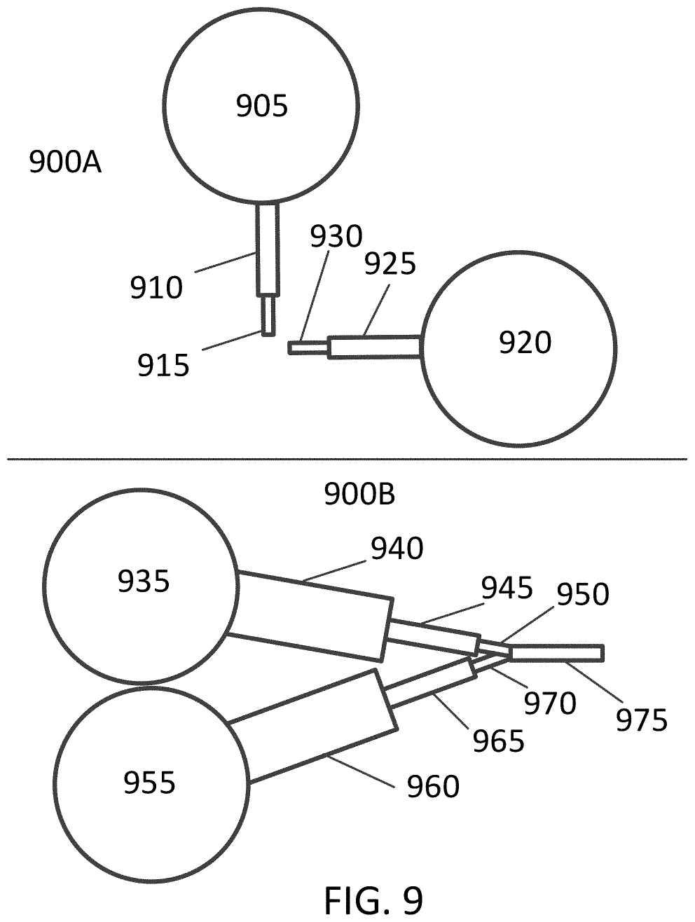

FIG. 9 illustrates two different sets of apparatus that may be used to produce products or materials consistent with the present disclosure. FIG. 9 includes a first apparatus 900A that includes a first material source 905, pipe 910, and nozzle 915. Apparatus 900A also includes a second material source 920, pipe 925, and nozzle 930. Material source 920 may source a combination of spider silk proteins and a liquid through pipe 925 and nozzle 930 when a spider web is fabricated. This process may include heating the source materials from material source 920 to critical temperatures and nozzle 930 may control the pressurization of this heated mixture. Material source 920, pipe 925, or nozzle 930 may include or be coupled to a heater that heats the materials to a desired temperature.

Source apparatus 905 may provide a second set of materials through pipe 910 and nozzle 915 as or immediately after spider webbing is formed. For example, when materials from source 905 include nanoparticles of graphene, these particles of particular sizes, these particles may be heated to a temperature that melts the particles. Since graphene has a breakdown temperature of about 130 degrees Celsius (C), materials that include graphene particles and possibly a liquid (e.g. water, other solvent, or liquid). This process could produce a graphene spider silk wire or cable that combines the natural strength of spider webbing and graphene that is more flexible than typical graphene. As mentioned above, previously fabricated spider webbing may be coated or partially coated.

FIG. 9 also includes apparatus 900B that also includes two different material sources, here however both of these sources provide materials to a same mixing nozzle 975. FIG. 9 includes material source 935, a heating element 940, pipe 945, and nozzle 945. FIG. 9 also includes material source 955, heating element 960, pipe 965, and nozzle 970. Material source 935 may provide a mixture of spider silk proteins and water, and material source 955 may provide a mixture of nanoparticles and water. Each of these material sources 935 & 955 may preheat their respective materials and these materials may be pumped through respective pipe 945 & 965 while be heated to critical temperatures by heaters 940 and 960. These materials may then move to nozzles 950 & 970 as they are mixed in mixing nozzle 975. As the combined materials move out of mixing nozzle 975 they may cool and form a composite material.

Nanoparticles may also be sprayed onto spider silk webbing and then the combination may be heated. Furthermore, this heating could occur in a pressurized environment. Such a spraying process may be similar to sandblasting or where a pressurized gas forcefully implants nanoparticles into the spider webbing. In other instances, a spray of materials may include a mixture of nanoparticles and a liquid or include particles that are deposited or implanted using ion implantation.

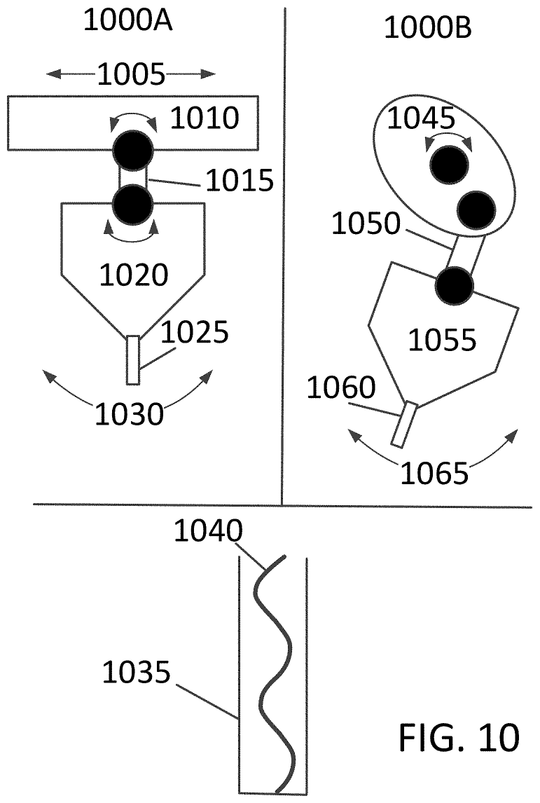

FIG. 10 illustrates exemplary camming apparatus that may move a nozzle to coat only portions of a spider web strand(s) with other materials. FIG. 10 illustrates two different camming mechanisms 1000A and 1000B that could be used to spray nanoparticles, a nanoparticles liquid mixture, or a melted substance on spider webbing. Camming mechanism 1000A includes part 1010, part 1015, and part 1020. Camming mechanism 1000A translates a side to side linear motion 1005 into a side to side arching motions as indicated by the curved arrowed lines shown on parts 1010 and 1020 of camming mechanism 1000A. Part 1015 is coupled to part 1010 to part 1020 by the two black circular pins of camming mechanism 1000A. The camming motion of mechanism 1000A causes nozzle 1020 to sweep along the rotational path 1030.

Camming mechanism 1000B includes an oval part 1035 that rotates from side to side around a center point as indicated by the curved arrowed line on part 1045. Camming mechanism 1000B also includes coupling part 1050 and part 1055. Part 1050 couples oval part 1045 to part 1055 via the two of the three black parts of camming mechanism 1000B. The rotation of part 1045 makes part 1055 and nozzle 1060 to rotate along rotational path 1065.

Nozzle 915 of FIG. 9 may include camming mechanism 1000A or 1000B may be used to spray materials 1040 onto spider webbing 1035 of FIG. 10. Note that the materials 1040 on webbing 1035 are sprayed in a curved path. In instances when webbing 1035 is more stretchable than materials 1040, webbing 1035 may be stretched until the curved path of materials 1040 straighten. At this point the flexibility of materials 1040 may begin to limit stretching of the overall composite material because materials 1040 are less stretchable than webbing 1035. Other patterns may be overlaid upon existing spider webbing, for example a crosshatched pattern or a pattern that circles around the webbing.

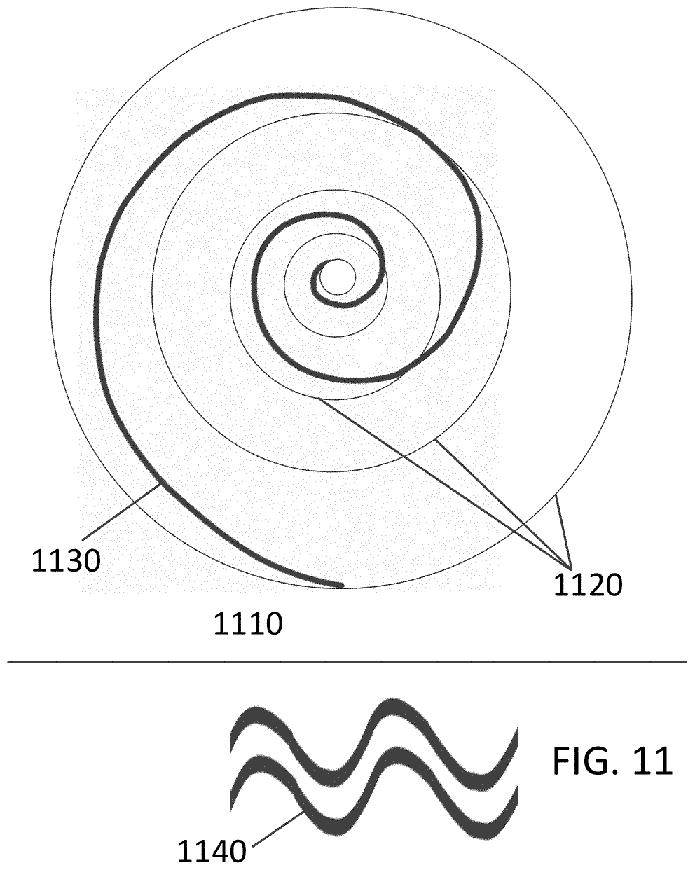

FIG. 11 illustrates features that may be included in nozzles that dispense combinations of materials at preferred temperatures and pressures. FIG. 11 illustrates an end view or cross sectional view of nozzle 1110 that includes a reducing size as illustrated by circles 1120 of different diameters. Nozzle 1110 also includes spiral element 1030 that may be a ridge or a depression. Much like a rile barrel, spiral element 1030 may impart rotational momentum upon elements that flow through nozzle 1110. Spiral element 1030 may be included in any nozzle consistent with the present disclosure no matter what the shape of that nozzle. As such, nozzles that have a constant diameter, nozzles that have a curved shape, nozzles that have a corkscrew like shape, or a changing shape (e.g. a reducing, an increasing shape, or combination thereof) may include spiral feature 1130.

Nozzle 1110 may be included in any of the apparatus consistent with the present disclosure, including, yet not limited to the nozzles previously discussed. As such, nozzle 1110 may impart rotational momentum upon protein particles, other particles, or combinations of particles whether or not the materials passed through the nozzle include liquids. FIG. 11 also includes nozzle 1140 of a curved shape. Nozzle 1140 may be in the shape of a corkscrew for example. FIG. 11 illustrates nozzle shapes and internal features that may enhance the mixing of materials passed through them by inducing spin/rotation momentum. This spinning force could increase a pressure within a nozzle increases such that materials are mixed and pressurized when processed. As such, proteins including manmade spider silk proteins and small particles including nanoparticles of various sorts may be combined.

A general equation for flow rate (Q) through a convergent nozzle is Q=(a constant K′) times a pressure P raised to a power of N or Q=C (P)N. For a general cross cut nozzle N is equal to 0.5 and for a nozzle of a given diameter Q=K D²(P)^{1/2}. Here flow rate corresponds to the product of a constant K, a diameter squared, and the square root of a pressure. In an instance when a convergent nozzle is used, a heating element may be coupled to the nozzle to heat the elements passing through the nozzle to a critical temperature and flow rate could be controlled to control pressure in the nozzle. While a convergent nozzle is discussed here, other nozzles, such as a convergent/divergent nozzle may be used as long as both pressure and temperature are controlled.

Exemplary critical temperatures associated with sintering BaTiO₃ (Barium Titanate, also referred to as Barium Titanium Oxide) nanoparticles is about 180 degrees C. An exemplary critical temperature for graphene may be a temperature that does not exceed 130 to about 135 degrees C., as temperatures above this are known to degrade graphene. These temperatures are also consistent with temperatures where spider silk proteins or webbing are stable. Desired pressures may be selected based on pressures and temperatures where spider silk proteins link to form webbing and temperatures where other materials do not degrade or where these other materials melt to form a composite material. For example, if a preferred pressure and temperature for forming spider silk proteins is about 861845 Pascal (i.e. 125 pound per square inch—PSI) and 125 degrees C., spider silk proteins may be combined with graphene nanoparticles at 125 PSI and 125 degrees C., where BaTiO₃ nanoparticles may be combined with spider silk proteins at 125 PSI and 180 degrees C. Of course depending on specific materials or material sizes these pressures and temperatures may be changed.

Particles combined with proteins may include particles of different types of initial materials, exemplary combinations include, yet are not limited to metals and graphene, metals and ceramics may be combined, ceramics and graphene, or other materials. Each of these initial materials may be combined in an initial process that does not exceed temperatures where another of these initial materials will degrade. After being combined at an initial set of conditions (e.g. an initial combination at a pressure & temperature) the combination may be exposed to yet higher temperatures than temperatures when the initial combination was formed when the combined materials are capable of withstanding this higher temperature.

In certain instances, proteins or webbing may be implanted or deposited with ions of particular materials using an ion implantation machine. This may include placing target materials (e.g. spider silk webbing, spider silk proteins, or proteins) in an ion implanter where ions from an ion source are accelerated toward the target. Here secondary processes may include combining the target material after they have been implanted or deposited with ions with critically sized particles using processes discussed herein. In such instances patterns like those illustrated or discussed in respect to FIG. 10 may be used to deposit or implant ions of metals or graphene onto spider webbing. This may be accomplished using a mask or screen disposed between the ion emitter and target materials. Here pattern 1040 of FIG. 10 may be an area where openings in the mask or screen are located. Band interference patterns may be deposited upon target materials in a manner similar to the classical double-split experiment in physics or may be created by diffraction. Alternatively, ions may be implanted by controlling the direction of a beam of ions when patterns are drawn on webbing material.

Materials consistent with the present disclosure may also include combining proteins such as glycoproteins, lipoproteins, fats, amino acids, or peptides, with other materials as discussed herein. Amino acids or peptides may also be combined with critically sized particles using methods consistent with the present disclosure. For example, the following amino acids of Hemoglobin A, Cytochrome C, Actin, and Fibroin-3 (ADF3) may be introduced into a vessel or stream in specific proportions and combined with critically sized particles in a vessel or in one or more streams passed through one or more nozzles.

In certain instances, small particles or nanoparticles of carbon absorbing materials (such as calcium citrate or Barium Titanate) may be combined with lipoproteins, fats, and potentially other proteins (e.g. like spider silk proteins) to create materials that may be distributed in, suspended in, or that float on top of water (including lake water) or salt water (like sea water). To create materials that that have a light color (such as white or off white), that include calories (in the form of fat and/or protein), and that include materials that absorb carbon dioxide. Such materials could be dispersed upon surfaces of the Artic or Antarctic Ocean or upon lakes and these materials could reflect Sunlight to reduce heat transfer from the Sunlight into the water. These materials may have been fabricated from nanoparticles, may be of a size that is small enough to be consumed by wildlife and may be large enough not to cause respiratory issues that may be associated with inhaling nanoparticles.

The density of saltwater at the surface of the oceans varies between 1020 to 1029 Kilograms per cubic meter (Kg/M³) or 1.020 to 1.029 grams per cubic centimeter (g/cm³). Saltwater in the deep oceans has a density of about 1050 Kg/M³ (1.050 g/cm³), spider webbing has a density of about 1.3 g/cm³, muscle has a density of 1.0599-1.1 g/cm³, fat has a density of 0.9 gm/cm³, and other materials that have been used to cause particles/nanoparticles to disperse throughout a water column have a density less than 1.02 g/cm³ (e.g. sodium octenyl succinate—a starch—has a density 1.0096 gm/cm³). Certain starchy materials, monosaccharides, or polysaccharides used in food product production have volumetric densities that approach or that are lower than the volumetric density of water or salt water. Very low density lipoproteins (VLDL) have a volumetric density less than 1.006 g/m³ and low density lipoproteins (LDL) have densities that range from 1.006-1.062 g/m³. Nanopartiles of heavy materials, such as calcium carbonate and Barium Titianate (BaTiO₃) are available for purchase in preparations that disperse in water.

In certain instances, combined materials may be sprayed through a nozzle with chilled water into the air at a high altitude or above the surface of water. In instances where air temperature is at or below the freezing temperature of water, ice may form around the combined materials above land or a body of water. This may help precipitate the formation of ice on land, lakes, or sea surfaces or act to form a type of snow or hail because of spontaneous freezing. Because of this freezing, even heavier materials combined with ice may be used to seed initial ice formation, whether these materials include light weight starchy materials, mono/polysaccharides, lipoproteins or not.

Another aspect of the present disclosure is to combine materials that have lower density with materials that have a higher density to create a materials that may include several of the following attributes: be of a color that reflects sunlight or that is light in color (e.g. white off white or materials that have a reflective index below a critical threshold), that has a tendency to float on or suspend in water/saltwater, that is non-toxic to animals, that provides nutrients to animals or micro-organisms, that is fermented by micro-organisms, and that absorb carbon dioxide. Such a material distributed on the surface of cold water/saltwater could help seed/initiate the formation of ice. By being light in color, the material would tend to reflect sunlight as it was suspended in the water column, the material could also act as a food source for lifeforms that could enhance or help support the food chain, and the material could absorb carbon dioxide. For example, a material made from calcium oxide, spider silk protein, and lighter materials (e.g. fat, low density forms of starch—sodium octenyl succinate, monosaccharides, or polysaccharides—and/or VLDL-LDL materials) could help form ice while providing food to organisms and absorbing carbon dioxide. The combining of these materials could begin with combining nanoparticles of materials that absorb carbon dioxide (e.g. calcium oxide, calcium carbonate, or Barium Titanate) with spider silk proteins to form a base material to which other materials could be added. Alternatively, the lighter materials may be combined with heavier materials in an initial step. These processes may include controlling the pressure and temperature in ways previously discussed. Here again initial processing steps may not exceed temperatures that destroy materials included in the combination. Such a process may provide a means to distribute materials over the surface of the ocean or an ice pack that could help initiate or maintain ice formation. Such materials may also be combined with non-toxic foams (e.g. a polysaccharide foam) that may itself contain materials that absorb carbon dioxide.

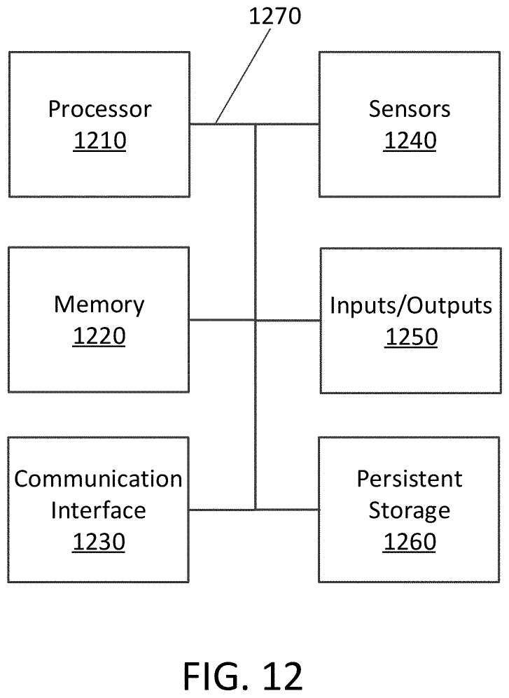

FIG. 12 illustrates a computing device that may be used to control or monitor apparatus consistent with the present disclosure. FIG. 12 includes process 1210, memory 1220, communication interface 1230, sensors 1240, inputs/outputs 1250, and persistent storage 1260 that may be connected to each other via communication bus 1270. In certain instances, sensors 1240 may communicate with processor 1210 via communication interface 1230 or via inputs/outputs 1250 using any standard or proprietary wired or wireless data transfer technology known in the art.

Processor 1210 may execute instructions out of memory 1220 when receiving data from sensors 1240. Processor 1210 may be any type of processing unit, microprocessor, or multi-processor known in the art. Communication interface 1230 may be used to communicate with other computing devices using wired or wireless communications known in the art. Exemplary communication interfaces 1230 include, yet are not limited to Ethernet, an 802.11, Bluetooth or other communication interface. Inputs/outputs may be coupled to other input or output devices, such as a display, a keyboard, a mouse, pumps, heating devices, cooling devices, valves, or other devices. Persistent data storage may be any storage device that retains data when power is turned off. As such, persistent storage 1260 may be a disk drive, FLASH memory, FERAM, phase change memory, or other persistent data storage type or combination of persistent data storage types.

Sensors 1240 may collect temperature or pressure data that processor 1210 may monitor temperatures or pressures and control heating or cooling devices, pumps, valves, or other apparatus to control or monitor processes consistent with the present disclosure.

While a control system including a processor have been discussed in respect to FIG. 12, other forms of electronic control systems may be used to control the operation of apparatus when materials consistent with the present disclosure are made. Digital logic, field programmable gate arrays (FPGA), and application specific integrated circuits are other types of electronic devices that may be used to build or that may be included in a system that controls apparatus that manufacture materials or parts consistent with the present disclosure.

Apparatus consistent with the present disclosure may include computer controlled equipment that monitors temperatures or other factors associated with methods consistent with the present disclosure. Methods consistent with the present disclosure may be implemented using a non-transitory computer readable storage medium where a processor executes instructions out of a memory.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A method for combining a protein containing material with critically sized particles of another material to form a product, the method comprising:
placing a first set of measures of critically sized particles of a material and a first set of measures of a protein in a vessel, the critically sized particles having a major dimension less than a first size; and
heating the measures of the critically sized particles and the protein to a first temperature that softens the critically sized particles of the material and that does not destroy the protein to form the product.

2. The method of claim 1, further comprising pressurizing an internal portion of the vessel to a pressure, wherein the pressure is provided by a press, a clamping force, a pressure in a chamber, or by injecting the first set of measures of critically sized particles of a material and the first set of measures of a protein into the vessel through one or more inputs of the vessel.

3. The method of claim 2, wherein the pressure is controlled to a pressure range of at least one of 50 pounds per square inch (PSI) to 100 PSI, 100 PSI to 200 PSI, 110 PSI to 140PSI, 200 PSI to 300 PSI, or above 300 PSI.

4. The method of claim 2, wherein the pressure is controlled to a pressure range of at least one of zero PSI to 100 PSI or 110 PSI to 150 PSI.

5. The method of claim 1, further comprising placing a second set of measures of the critically sized particles of the material and a second set of measures of the protein in the vessel before heating the vessel, wherein each of the respective measures of the material and the protein are placed in alternating layers.

6. The method of claim 1, further comprising heating the product to a second temperature that exceeds the temperature that destroys the protein.

7. The method of claim 1, wherein the major dimension is less than at least one of 1000 micrometers, 1000 nanometers, or 100 nanometers.

8. The method of claim 1, wherein the major dimension is less than 1000 nanometers.

9. The method of claim 1, wherein the protein includes spider silk proteins.

10. The method of claim 1, wherein the protein includes webbing made using materials from a genetically engineered organism.

11. A method for combining a protein containing material with critically sized particles of another material, the method comprising:
controlling a controlled flow of the protein containing material through a first nozzle of one or nozzles; and
controlling a flow of a heated material that includes critically sized particles through at least one of the first nozzle or a second nozzle of the one or more nozzles, wherein proteins in the protein containing material and the critically sized particles are combined based on the heating of the critically sized particles and the passage of the protein containing material and the heated material through the one or more nozzles.

12. The method of claim 11, wherein the protein containing material includes a liquid.

13. The method of claim 11, wherein the critically sized particles have a major dimension less than 100 micro-meters.

14. The method of claim 11, wherein the critically sized particles have a major dimension less than 1000 nanometers.

15. The method of claim 11, wherein the temperatures melt the critically sized particles.

16. A method for combining critically sized particles with a webbing material that includes spider silk proteins, the method comprising:
placing a portion of the webbing material that includes the spider silk proteins in proximity to an apparatus that distributes a portion of the critically sized particles onto at least a part of the portion webbing material; and
distributing the portion of the first material onto the webbing material based at least in part on the webbing material being placed in proximity to the apparatus.

17. The method of claim 16, further comprising heating the combination of the webbing material and the distributed portion of the first material to a temperature that softens the portion of the first material.

18. The method of claim 16, wherein the portion of the first material includes particles that have a major dimension that is smaller than 1500 nanometers.

19. The method of claim 18, wherein the particles are ions distributed by accelerating the ions by an electric field.

20. The method of claim 16, further comprising heating the portion of the first material, wherein the portion of the first material is distributed by passing the portion of the first material through a nozzle.
